(19) United States
(12) Patent Application Publication
(10) Pub. No.: US 2014/0125085 A1
(43) Pub. Date: May 8, 2014

(54) ATTACHMENT STRUCTURE OF INFORMATION DISPLAY DEVICE FOR VEHICLE

(71) Applicant: MAZDA MOTOR CORPORATION, Hiroshima (JP)

(72) Inventors: Daisuke WAKIBAYASHI, Hiroshima-city (JP); Katsuyuki TAKAHASHI, Hatsukaichi-city (JP)

(73) Assignee: MAZDA MOTOR CORPORATION, Hiroshima (JP)

(21) Appl. No.: 14/070,056

(22) Filed: Nov. 1, 2013

(30) Foreign Application Priority Data
Nov. 6, 2012 (JP) 2012-244256

(51) Int. Cl. B60K 37/02

(52) U.S. Cl. CPC B60K 37/02
USPC 296/70

(57) ABSTRACT

A HUD unit is provided at an upper portion of a meter unit such that a half mirror is positioned in front of a display surface of the meter unit and an upper face of the half mirror is capable of constituting a design face. A support bracket is attached to an instrument panel member supporting an instrument panel. A front end portion of the HUD unit is attached to the support bracket so as to be supported at the support bracket. Accordingly, manufacturing of two different models with or without the HUD unit can be facilitated, driving assist information can be displayed with as less changing of driver's eyes or focus of driver's eye as possible, and a mounting state of the HUD unit can be stabilized.

### BACKGROUND OF THE INVENTION

The present invention relates to an attachment structure of an information display device for a vehicle which comprises a meter unit and an information display device including a display portion to display driving assist information for a passenger and an emitting portion to emit display contents of the driving assist information at the display portion, the meter unit and the information display device being provided at an instrument panel.

Conventionally, a head-up display is known as an information display device for a vehicle to display driving assist information, such as a present (current) vehicle speed, a target vehicle speed for an auto cruse driving, brief navigation information, for a passenger (see Japanese Patent Laid-Open Publication No. H04-184480).

In the device disclosed in the above-described patent publication, a semitransparent display portion (a half minor) is provided at a windshield and an emitting portion to emit display contents of the driving assist information is provided at an instrument panel at a position below the display portion, so that the driving assist information can be displayed properly with as less changing of driver's eyes or focus of driver's eye as possible.

Herein, there was a problem in that in a case in which a vehicle has two different models: one is equipped with the information display device for a vehicle; the other is not equipped with the information display device for a vehicle, it would be necessary to manufacture its instrument panel differently for the two models.

It may be considered in order to avoid the above-described necessity that the display portion and the emitting portion are constituted integrally as a head-up display unit and then this display unit is provided at an upper portion of the meter unit. Thereby, the two different models with or without the information display device can be properly manufactured only by manufacturing a meter hood which may be generally provided at the upper portion of the meter unit differently for such different models.

In this case, it is preferable that the display portion be arranged far away from the passenger (i.e., at a forward position, specifically, in front of a display surface of the meter unit) in order to make the best use of an advantage of less changing of driver's eyes or focus of driver's eye which is the feature of the information display device for a vehicle. Further, when considering mounting of the information display device at the upper portion of the meter unit, decreasing the number of parts may be properly achieved by using the upper face of the meter unit as a design face (i.e., a formative face which is viewable from a passenger or the like) of the meter hood.

If the above-described structure is applied, however, the display portion is located at a relatively forward position and also it is necessary to configure the upper face of the meter hood (i.e., the design face of the upper face of the information display device for a vehicle) to slant forward and downward from a perspective of relationships of the driver's eyes and the front visual range. Accordingly, the gravity center of the head-up display unit is positioned relatively forward and the head-up display unit takes a slant position in which its front portion is located downward compared with its rear portion. Consequently, there is a concern that the mounting state of the head-up display unit may become considerably unstable during the longitudinal acceleration/deceleration of the vehicle.

### SUMMARY OF THE INVENTION

An object of the present invention is to provide an attachment structure of an information display device for a vehicle which can facilitate manufacturing of two different models with or without the information display device, display the driving assist information with as less changing of driver's eyes or focus of driver's eye as possible, and stabilize the mounting state of the information display device.

According to the present invention, there is provided a vehicle-body structure of an attachment structure of an information display device for a vehicle, comprising an instrument panel, a meter unit provided at the instrument panel, an information display device including a display portion to display driving assist information for a passenger and an emitting portion to emit display contents of the driving assist information at the display portion, the information display device being provided at an upper portion of the meter unit such that the display portion is positioned in front of a display surface of the meter unit and an upper face of the display portion is capable of constituting a design face (i.e., a formative face which is viewable from a passenger or the like), an instrument panel member supporting the instrument panel, and a support bracket attached to the instrument panel member, wherein a front end portion of the information display device is attached to the support bracket so as to be supported at the support bracket.

According to the present invention, by constituting the display portion and the emitting portion of the information display device as a single unit and also by providing this display device at the upper portion of the meter unit such that the upper face of the display portion constitutes the design face, two different models with or without the information display device can be properly manufactured only by manufacturing a meter hood provided at the upper portion of the meter unit differently for such different models. Thereby, manufacturing of the two different models can be facilitated.

Further, by providing the information display device such that the display portion is positioned in front of the display surface of the meter unit, the display surface of the meter unit can be arranged properly far away from a passenger seated in a driver's seat. Thereby, the driving assist information can be displayed with as less changing of driver's eyes or focus of driver's eye as possible.

Moreover, by configuring such that the front end portion of said information display device is supported at the support bracket attached to the instrument panel member, the information display device can be supported stably even in a case in which the information display device is arranged such that the display portion is positioned in front of the display surface of the meter unit at the upper portion of the meter unit.

According to an embodiment of the present invention, the information display device is fixed to the upper portion of the meter unit by a fixation portion which is positioned in back of the display portion thereof, the information display device fixed by the fixation portion is attached to the instrument panel together with the meter unit, and the meter unit is attached to the instrument panel such that the display surface thereof slants upward and forward. Thereby, the productivity and the visibility of the meter unit can be properly improved with a stable support of the meter unit and the information display device. Specifically, by fixing the information display device to the upper portion of the meter unit by means of the fixation portion and also by attaching the information display device to the instrument panel together with the meter unit, the information display device can be assembled to the instrument panel after it has been sub-assembled to the meter unit. Thereby, the productivity can be improved. Further, by attaching the meter unit to the instrument panel such that the display surface of the meter unit slants upward and forward, the display surface of the meter unit can be inclined so as to be directed toward the position of the eyes of the passenger seated in the driver's seat. Thereby, the visibility of the display surface of the meter unit can be improved. Additionally, in this case, the meter unit and the information display device which are integrated as one unit through sub-assembling are mounted in a forward-overhanging state which is substantially of an inverse L shape in a side view, so that the mounting state normally becomes considerably unstable. According to the present embodiment, however, by supporting the front end portion of the information display device at the support bracket, the meter unit and the information display device can be supported properly stably.

According to another embodiment of the present invention, an upper end portion of the support bracket supports a portion of the instrument panel which is located in the vicinity of an upper face of the instrument panel. Thereby, a relative position of the information display device to the instrument panel can be properly restricted by the support bracket. Accordingly, any positional difference (gap) of the upper face of the information display device and the upper face of the instrument panel can be prevented surely, so that good appearances of the design face can be ensured.

According to another embodiment of the present invention, the support bracket is formed to have substantially a U-shaped cross section in a plane perpendicular to a longitudinal direction thereof, and has cut-out portions which open rearward at a middle portion thereof, and a duct for air conditioning is arranged behind the cut-out portions of the support bracket. Herein, the cross section of the duct arranged behind the support bracket can be made properly wide by the above-described cut-out portions. Further, since the support bracket is attached to the instrument panel at a portion thereof which has a greater longitudinal-wide than another portion thereof where the cut-out portions are formed, the strength against a longitudinal load can be properly increased.

According to another embodiment of the present invention, the display portion of the information display device is movable between a display position for displaying the driving assist information for the passenger and a non-display position for enabling the upper face of the display portion to constitute the design face, and the information display device comprises a motor unit to move the display portion. Thereby, the information display device can be supported stably, the facility can be improved, and also the sense of quality can be improved. Specifically, by moving the display portion by means of the motor unit, the facility of the information display device for the passenger can be improved and the sense of quality can be improved. In this case, the motor unit causes an increase of the weight of the information display device, so that the mount state of the information display device may become unstable. According to the above-described embodiment, however, since the front end portion of the information display device is supported at the support bracket, the information display device can be supported properly stably.

Other features, aspects, and advantages of the present invention will become apparent from the following description which refers to the accompanying drawings.

### BRIEF DESCRIPTION OF THE DRAWINGS

FIG. 1 is a perspective view showing an instrument panel equipped with an attachment structure of an information display device for a vehicle according to an embodiment of the present invention.

FIG. 2 is a sectional view taken along line A-A of FIG. 1.

FIG. 3 is an exploded perspective view showing a head-up display unit and a meter unit.

FIG. 4 is a perspective view showing a support bracket and its surrounding portion.

FIG. 5 is a perspective view of the support bracket.

FIG. 6 is an explanatory diagram explaining an attachment of the head-up display unit and the meter unit.

### DETAILED DESCRIPTION OF THE INVENTION

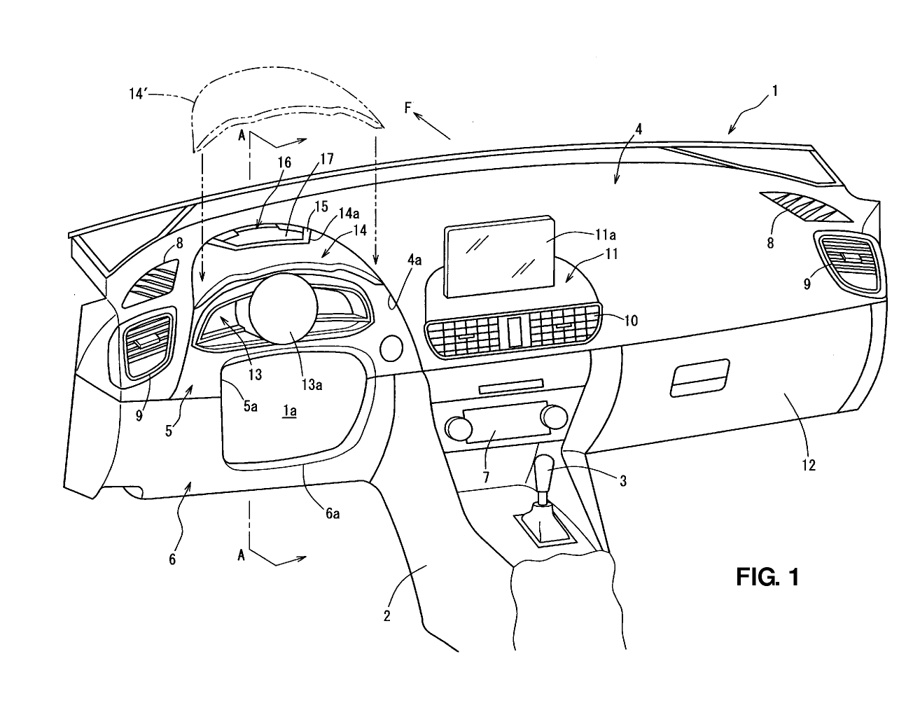

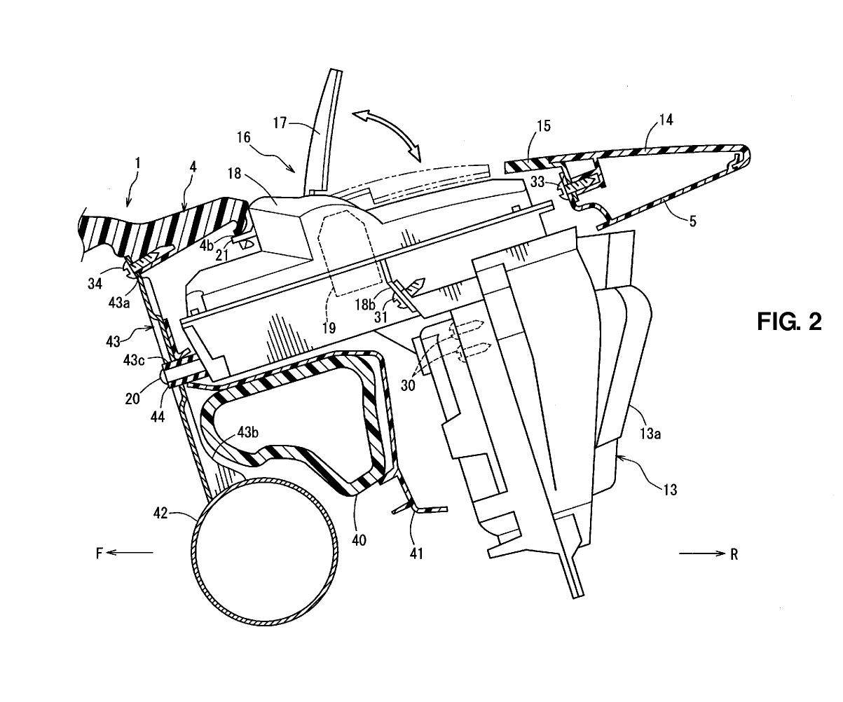

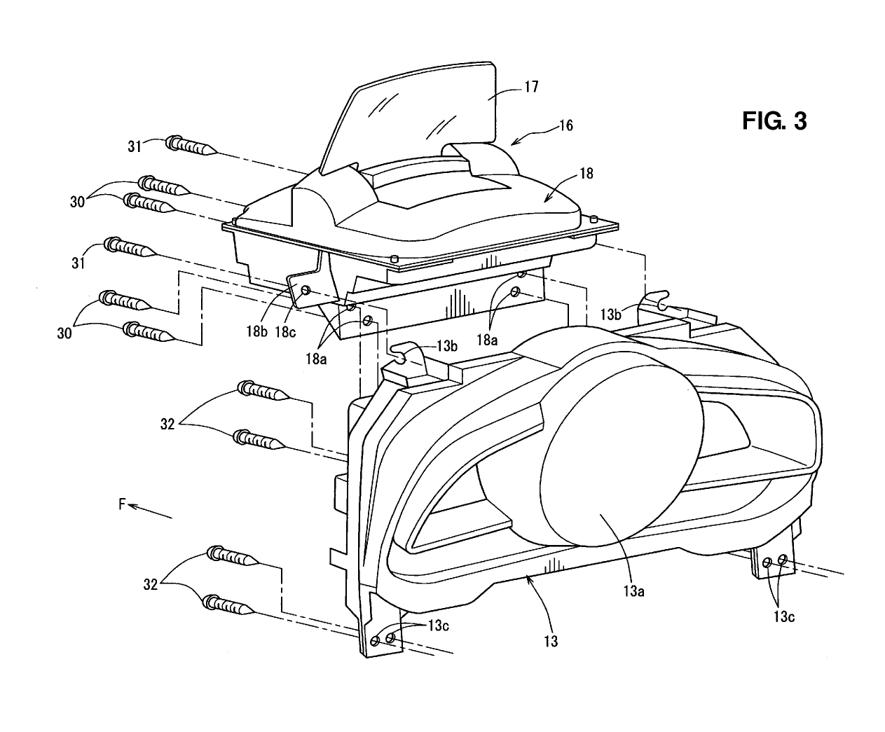

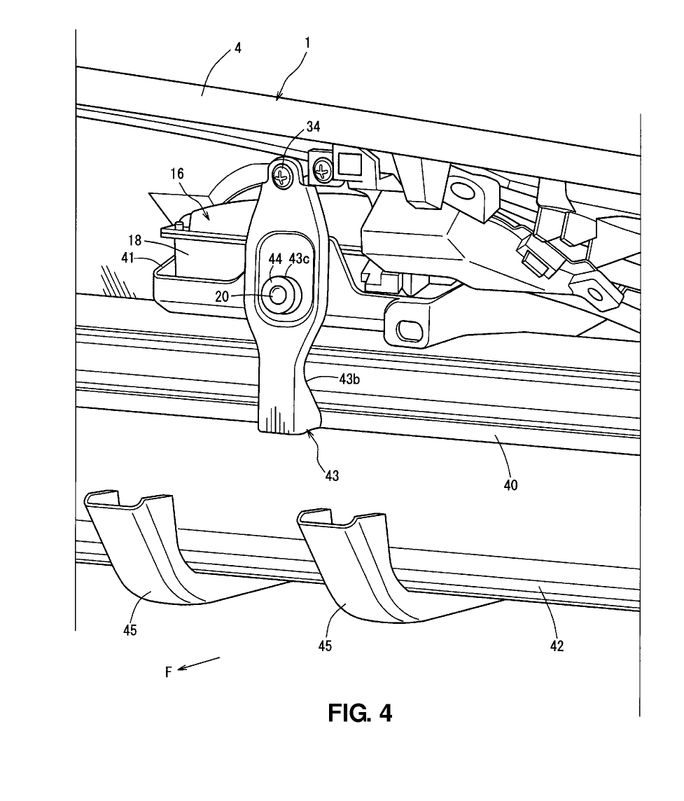

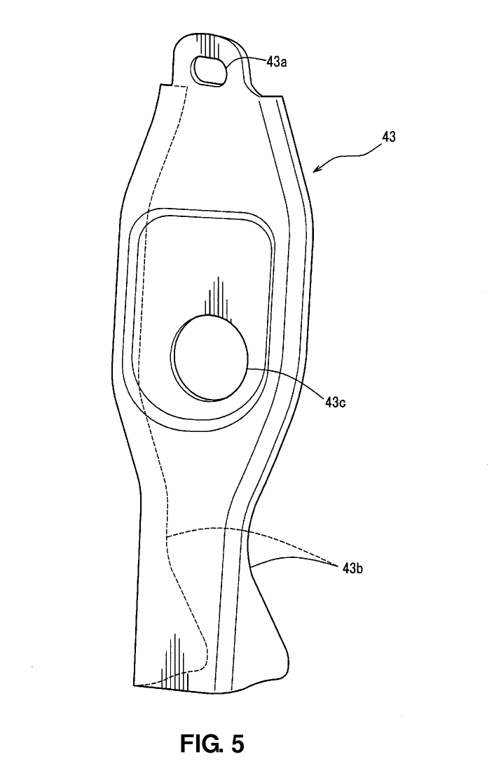

Hereinafter, a preferred embodiment of the present invention will be described specifically referring to the accompanying drawings. FIG. 1 is a perspective view showing an instrument panel equipped with an attachment structure of an information display device for a vehicle according to an embodiment of the present invention. FIG. 2 is a sectional view taken along line A-A of FIG. 1. FIG. 3 is an exploded perspective view showing a head-up display unit and a meter unit. FIG. 4 is a perspective view showing a support bracket and its surrounding portion. FIG. 5 is a perspective view of the support bracket. In the drawings, an arrow F shows a vehicle front and an arrow R shows a vehicle rear. A direction of members will be described based on a direction of the vehicle in the present specification. For example, a side which faces a driver's seat will be described as “rear” or “rearward,” and its opposite side will be described as “front” or “forward.”

As shown in FIG. 1, an instrument panel 1 is provided to extend in a vehicle width direction over a whole vehicle's width at a front portion of a vehicle compartment, and a console portion 2 which partitions a driver's-seat side from a passenger-seat side is provided to extend rearward from a central portion, in the vehicle width direction, of the instrument panel 1. A shift lever 3 of an automatic transmission is provided at an upper face portion of the console portion 2.

The instrument panel 1 is comprised of an instrument panel body 4 extending in the vehicle width direction over the whole vehicle's width, a frame member 5 provided on the driver's-seat side (the left side in the figure), and a lower panel 6 provided below the frame member 5. Herein, a portion la of the instrument panel 1 shown in FIG. 1 is an opening portion which is made by cut-out portions 5a, 6a which are formed at a lower portion of the frame member 5 and an upper portion of the lower panel 6, respectively. A steering device comprised of a steering wheel, a steering shaft, and others (not illustrated) is attached through the opening portion 1a.

Further, an audio device and an operational unit 7 of an air conditioner for controlling a temperature and the like of the vehicle compartment are provided at the central portion, in the vehicle width direction, of the instrument panel 1. Conditioning-air outlets 8-10 for supplying conditioning air into the vehicle compartment are provided at the driver's-seat side, the passenger-seat side (the right side in the figure) and the central portion, in the vehicle width direction, of the instrument panel 1. Another arrangement of the driver's seat and the passenger's seat which is opposite to the above-described arrangement is applicable as well.

Moreover, a navigation device 11 for displaying additional driving assist information, such as map information, present-location information, or brief navigation information, is arranged at the central portion, in the vehicle width direction, of the instrument panel 1. The navigation device 11 includes a display device 11a which is controlled to be vertically moveable (i.e., going up or down) by means of a drive mechanism (not illustrated). FIG. 1 shows a state of the display device 11a during a vehicle travelling, in which the display device 11a stands up from the central portion, in the vehicle width direction, of the instrument panel 1 and displays the above-described driving assist information for a passenger.

Also, a glove compartment 12 for storing small articles is provided at the instrument panel 1 on the passenger-seat side. Meanwhile, a meter unit 13, a meter hood 14 for covering the meter unit 13, a frame member 15, and a head-up display unit 16 (hereinafter, referred to as “HUD unit” briefly) are provided at the instrument panel 1 on the driver's-seat side.

A cut-out portion 4a which is configured to have substantially a half-circular shape and open rearward is formed at an instrument panel body 4 of the instrument panel 1 on the diver's-seat side. The above-described frame member 5 is attached to a rear portion (a lower portion) of the cut-out portion 4a, and a meter unit 13 is placed into an opening portion of the frame member 5.

Meanwhile, the meter hood 14 is attached to a front portion (an upper portion) of the cut-out portion 4a of the instrument panel body 4, covering over the meter unit 13. In the present embodiment, a cut-out portion 14a which is of substantially a trapezoidal shape is formed at a front portion of the meter hood 14, and the frame member 15 which is of substantially a U shape is arranged along the cut-out portion 14a. The above-described HUD unit 16 is placed into an opening portion which is formed by the cut-out portion 4a and the frame member 15.

The meter unit 13 includes a display portion of meters, such as a vehicle-speed meter and a fuel meter, and a shift-position displayer of the shift lever 3 and others. Herein, a display surface 13a of the meter unit 13 is arranged to face the driver's seat so that the additional driving assist information, such as the present vehicle speed, the amount of remaining fuel, and the shift position, can be displayed for the passenger. The meter unit 13 is attached to the instrument panel 1 such that its display surface 13a slants upward and forward.

The HUD unit 16 primarily comprises, as shown in FIGS. 1-4, a half mirror 17 to display for the passenger the additional driving assist information, such as the present vehicle speed, the target vehicle speed for the auto cruse driving, and the brief navigation information, an emitting portion 18 to emit display contents of the driving assist information at the half minor 17, a motor unit 19 to drive the half minor 17 for its opening or closing, and two pins 20, 21 which respectively extend forward from a front end portion of the emitting portion 18.

The half mirror 17 is rotatably supported at a pivotal axis (not illustrated) so as to take its opening and closing positions. Thereby, the half minor 17 is movable between its display position (its opening position illustrated by solid lines in FIG. 2) where it stands up from an upper face of the meter hood 14 for displaying the driving assist information for the passenger, and its non-display position (its closing position illustrated by two-dotted broken lines in FIG. 2).

Also, the half minor 17 is, as shown in FIGS. 1 and 2, positioned in front of the display surface 13a of the meter unit 13. Thus, the half mirror 17 in the display position (the opening position) is arranged far away from the passenger. Accordingly, the driving assist information can be displayed properly with as less changing of driver's eyes or focus of driver's eye as possible.

Further, the half minor 17 has a surface face which is of a curve shape, and the half minor 17 in the non-display position (the closing position) constitutes a design face together with the upper face of the meter hood 14 which is of a curve shape as shown in FIG. 1.

The motor unit 19 comprises a motor to generate a rotational force and a reduction gear to transmit the rotational force of the motor to the half mirror 17, and drives the half minor 17 so that the half minor 17 can open and close at a proper speed.

Also, through holes 18a are formed at both sides of the emitting portion 18 as shown in FIG. 3. The through holes 18a are positioned in back of the half mirror 17, and by attaching the emitting portion 18 to a front face of the meter unit 13 by means of screws 30 inserted into the through holes 18a, the HUD unit 16 is fixed to the upper portion of the meter unit 13 at a position which is located in back of the half minor 17.

Moreover, the emitting portion 18 has a pair of flange portions 18b which extend outward in the vehicle width direction near the through holes 18a, and a second through hole 18c is formed at each of the flange portions 18b. Meanwhile, a pair of through opening portions 13b for screws 31 inserted therein are formed at the meter unit 13 at positions which correspond to the through holes 18c. In the present embodiment, by inserting the screws 31 into the through holes 18c and the through opening portions 13b such that the emitting portion 18 and the meter unit 13 are screwed up at a specified position of the instrument panel 1, three of the HUD unit 16, the meter unit 13 and the instrument panel 1 are fastened together.

Further, through holes 13c are formed at both-side lower portions of the meter unit 13. In the present embodiment, by inserting screws 32 into the through holes 13c, the lower portions of the meter unit 13 is fixed to the instrument panel 1.

As described above, in the present embodiment, the HUD unit 16 is fixed to the upper portion of the meter unit 13 at a position which is located in back of the half mirror 17. The HUD unit 16 fixed by the screws 30 is attached to the instrument panel 1 together with the meter unit 13 by the screws 31, 32 and others.

Herein, in back of the meter unit 13, as shown in FIG. 2, the meter hood 14, the frame member 15, and the frame member 5 of the instrument panel 1 are fastened together by the screws 33, and a rear end portion of the meter hood 14 engages with a rear end portion of the frame member 5. Thereby, rear portions of the meter hood 14 and the frame member 15 are fixed to a specified position of the instrument panel 1.

Further, in front of the meter unit 13, a duct 40 for air conditioning of the vehicle which supplies the conditioning air generated by the air conditioner to the conditioning-air outlets 8-10 is arranged below the HUD unit 16 as shown in FIGS. 2 and 4. An upper portion and a rear portion of the duct 40 are covered with a cover member 41 which has substantially an inverse-L shaped cross section in a side view.

A cylindrical instrument panel member 42 which interconnects both-side hinge pillars (not illustrated) and supports the instrument panel 1, the above-described steering device and others is provided to extend in the vehicle width direction at a position located in front of and below the duct 40.

A support bracket 43 shown in FIGS. 2, 4 and 5 is joined to the instrument panel member 42. The support bracket 43 is a member extending vertically from the instrument panel member 42 to the vicinity of the upper face of the instrument panel 1, a lower end portion of which is joined to the instrument panel member 42 and an upper end portion of which has a through hole 43a. The upper end portion of the support bracket 43 is fixed to the vicinity of the upper face of the instrument panel 1 by a screw 34 inserted into the through hole 43a, so that the instrument panel 1 is supported at the support bracket 43 at the vicinity of the upper face thereof.

The above-described support bracket 43 has substantially a U-shaped cross section in a plane perpendicular to a longitudinal direction thereof (in the vertical direction in the present embodiment), and also has cut-out portions 43b which open rearward at a middle portion thereof. The above-described duct 40 is arranged behind the cut-out portions 43a.

Further, the support bracket 43 has a through hole 43c above the cut-out portions 43b, and the lower-side pin 20 arranged at the front end portion of the emitting portion 18 is inserted into the through hole 43c. Herein, a cylindrical rubber bush 44 is provided between the pin 20 and the an edge portion of the through hole 43c. The front end portion of the HUD unit 16 is resiliently supported at the support bracket 43 via the rubber bush 44.

Also, the upper-side pin 21 arranged in front of the half minor 17 is inserted into an engaging hole 4b formed at the instrument panel body 4, and the front portion of the HUD unit 16 is supported at the instrument panel body 4.

In FIG. 4, a pair of members 45, 45 which have a U-shaped cross section and are joined to a lower portion of the instrument panel member 42 are a steering support bracket to support the above-described steering device.

When the meter unit 13 and the HUD unit 16 are attached to the instrument panel 1, the HUD unit 16 is fixed to the upper portion of the meter unit 13 by the screws 30 for sub-assembling first.

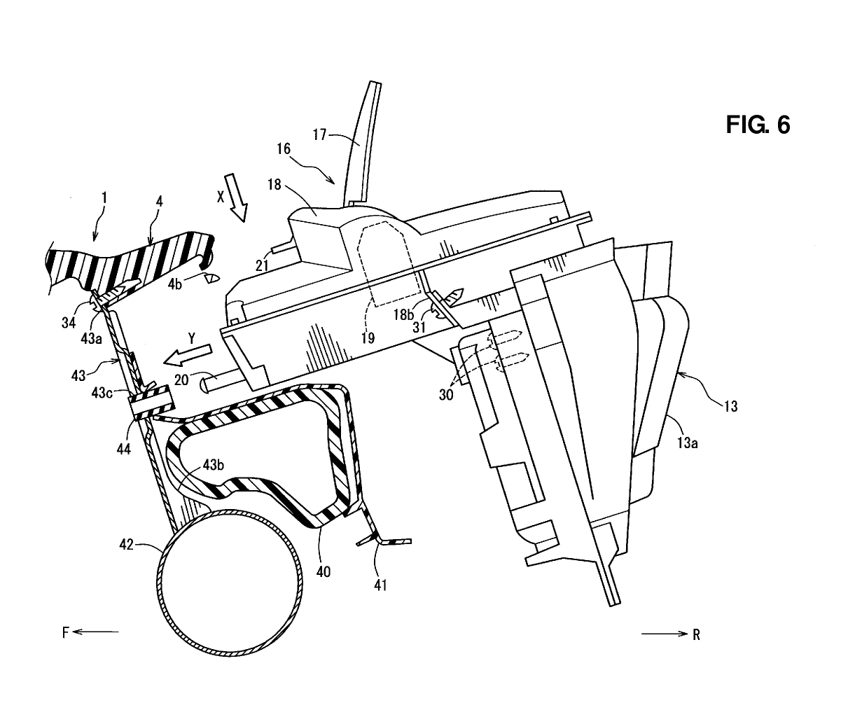

Next, the sub-assembly of the meter unit 13 and the HUD unit 16 is moved along a bold arrow X direction shown in FIG. 6, so that a lower face of the HUD unit 16 (the emitting portion 18) contacts the cover member 41. Then, the sub-assembly of the meter unit 13 and the HUD unit 16 is slid along the cover member 41 in a bold arrow Y direction shown in FIG. 6, so that the pins 20, 21 are respectively inserted into the through hole 43c (a hollow portion of the rubber bush 44) of the support bracket 43 and the engaging hole 4b of the instrument panel body 4. Thereby, positioning of the front portion of the HUD unit 16 is conducted. Finally, the meter unit 13 and the HUD unit 16 are fixed to the instrument panel 1 by the screws 31, 32 and others.

According to the present embodiment, by constituting the half mirror 17 and the emitting portion 18 as a single unit of the HUD unit 16 and also by providing this HUD unit 16 at the upper portion of the meter unit 13 such that the upper face of the half mirror 17 constitutes the design face, the two different models with or without the HUD unit 16 can be properly manufactured only by manufacturing the meter hood 14 provided at the upper portion of the meter unit 13 differently for such different models. Thereby, manufacturing of the two different models can be facilitated.

Herein, the meter hood 14 having the cut-out 14a for the HUD unit 16 (the half mirror 17) is used for the model with the HUD unit 16 as shown by a solid line in FIG. 1. Meanwhile, a meter hood 14′ having no cut-out is used for the model without the HUD unit 16 as shown by a two-dotted broken line in FIG. 1.

Further, by providing the HUD unit 16 such that the half minor 17 is positioned in front of the display surface 13a of the meter unit 13, the half mirror 17 can be arranged properly far away from the passenger seated in the driver's seat. Thereby, the driving assist information can be displayed with as less changing of driver's eyes or focus of driver's eye as possible.

Moreover, by configuring such that the front end portion of the HUD unit 16 is supported at the support bracket 43 attached to the instrument panel member 42, the HUD unit 16 can be supported stably even in a case in which the HUD unit 16 is arranged such that the half mirror 17 is positioned in front of the display surface 13a of the meter unit 13 at the upper portion of the meter unit 13.

Further, the HUD unit 16 is fixed to the upper portion of the meter unit 13 by the screws 30 which is positioned in back of the display portion 13a thereof, this HUD unit 16 is attached to the instrument panel 1 together with the meter unit 13, and the meter unit 13 is attached to the instrument panel 1 such that the display surface 13a thereof slants upward and forward. Thereby, the productivity and the visibility of the meter unit 13 can be properly improved with a stable support of the meter unit 13 and the HUD unit 16.

Specifically, by fixing the HUD unit 16 to the upper portion of the meter unit 13 by means of the screws 30 and also by attaching the HUD unit 16 to the instrument panel 1 together with the meter unit 13, the HUD unit 16 can be assembled to the instrument panel 1 after it has been sub-assembled to the meter unit 13. Thereby, the productivity can be improved.

Further, by attaching the meter unit 13 to the instrument panel 1 such that the display surface 13a of the meter unit 13 slants upward and forward, the display surface 13a of the meter unit 13 can be inclined so as to be directed toward the position of the eyes of the passenger seated in the driver's seat. Thereby, the visibility of the display surface 13a of the meter unit 13 can be improved.

Additionally, in this case, the meter unit 13 and the HUD unit 16 which are integrated as one unit through sub-assembling are mounted in a forward-overhanging state which is substantially of an inverse L shape in a side view as shown in FIG. 2, so that the mounting state normally becomes considerably unstable. According to the present embodiment, however, by supporting the front end portion of the HUD unit 16 at the support bracket 43, the meter unit 13 and the HUD unit 16 can be supported properly stably.

Also, by configuring such that the upper end portion of the support bracket 43 supports a portion of the instrument panel 1 which is located in the vicinity of the upper face of the instrument panel 1, a relative position of the HUD unit 16 to the instrument panel 1 can be properly restricted by the support bracket 43. Accordingly, any positional difference (gap) of the upper face of the HUD unit 16 (the half mirror 17) and the upper face of the instrument panel 1 can be prevented surely, so that good appearances of the design face can be ensured.

Moreover, by configuring such that the support bracket 43 has the cut-out portions 43b which open rearward, the cross section of the duct 40 arranged behind the support bracket 43 can be made properly wide by the cut-out portions 43b. Further, since the support bracket 43 is attached to the instrument panel 1 at a portion thereof which has a greater longitudinal-wide than another portion thereof where the cut-out portions 43b are formed (i.e., at a lower end portion of the support bracket 43 in the present embodiment), the strength against a longitudinal load can be increased.

Further, by providing the motor unit 19 to move (open or close) the half minor 17, the HUD unit 16 can be supported stably, the facility can be improved, and also the sense of quality can be improved.

Specifically, by moving the half mirror 17 with the motor unit 19, the facility of the HUD unit 16 for the passenger can be improved and the sense of quality can be improved.

In this case, the motor unit 19 causes an increase of the weight of the HUD unit 16, so that the mount state of the HUD unit 16 may become unstable. According to the above-described embodiment, however, since the front end portion of the HUD unit 16 is supported at the support bracket 43, the HUD unit 16 can be supported properly stably.

The present invention should not be limited to the above-described embodiment, and any other modifications or improvements may be applied within the scope of a sprit of the present invention. For example, while the above-described embodiment shows the case in which the HUD unit 16 is fixed to the upper portion of the meter unit 13 by the screws 30, the HUD unit may be fixed to the upper portion of the meter unit via an engagement connection between an engaging portion which is arranged at or integrally formed with a rear portion of the half mirror and an engaged portion which is arranged at or integrally formed with an upper portion of the meter unit. In this case, the fixation portion is comprised of the above-described engaging portion and the above-described engaged portion.

Herein, the display portion of the present invention corresponds to the half minor 17 of the present embodiment. Likewise, the information display device for a vehicle corresponds to the HUD unit 16, and the fixation portion corresponds to the screws 30.

What is claimed is:

1. An attachment structure of an information display device for a vehicle, comprising:
an instrument panel;
a meter unit provided at the instrument panel;
an information display device including a display portion to display driving assist information for a passenger and an emitting portion to emit display contents of the driving assist information at the display portion, the information display device being provided at an upper portion of the meter unit such that the display portion is positioned in front of a display surface of the meter unit and an upper face of the display portion is capable of constituting a design face;
an instrument panel member supporting the instrument panel; and
a support bracket attached to the instrument panel member,
wherein a front end portion of said information display device is attached to said support bracket so as to be supported at the support bracket.

2. The attachment structure of an information display device for a vehicle of claim 1, wherein said information display device is fixed to the upper portion of said meter unit by a fixation portion which is positioned in back of the display portion thereof, the information display device fixed by the fixation portion is attached to said instrument panel together with the meter unit, and the meter unit is attached to the instrument panel such that the display surface thereof slants upward and forward.

3. The attachment structure of an information display device for a vehicle of claim 2, wherein an upper end portion of said support bracket supports a portion of said instrument panel which is located in the vicinity of an upper face of the instrument panel.

4. The attachment structure of an information display device for a vehicle of claim 1, wherein an upper end portion of said support bracket supports a portion of said instrument panel which is located in the vicinity of an upper face of the instrument panel.

5. The attachment structure of an information display device for a vehicle of claim 3, wherein said support bracket is formed to have substantially a U-shaped cross section in a plane perpendicular to a longitudinal direction thereof, and has cut-out portions which open rearward at a middle portion thereof, and a duct for air conditioning is arranged behind said cut-out portions of the support bracket.

6. The attachment structure of an information display device for a vehicle of claim 1, wherein said support bracket is formed to have substantially a U-shaped cross section in a plane perpendicular to a longitudinal direction thereof, and has cut-out portions which open rearward at a middle portion thereof, and a duct for air conditioning is arranged behind said cut-out portions of the support bracket.

7. The attachment structure of an information display device for a vehicle of claim 2, wherein said support bracket is formed to have substantially a U-shaped cross section in a plane perpendicular to a longitudinal direction thereof, and has cut-out portions which open rearward at a middle portion thereof, and a duct for air conditioning is arranged behind said cut-out portions of the support bracket.

8. The attachment structure of an information display device for a vehicle of claim 4, wherein said support bracket is formed to have substantially a U-shaped cross section in a plane perpendicular to a longitudinal direction thereof, and has cut-out portions which open rearward at a middle portion thereof, and a duct for air conditioning is arranged behind said cut-out portions of the support bracket.

9. The attachment structure of an information display device for a vehicle of claim 5, wherein said display portion of the information display device is movable between a display position for displaying the driving assist information for the passenger and a non-display position for enabling the upper face of the display portion to constitute the design face, and said information display device comprises a motor unit to move the display portion.

10. The attachment structure of an information display device for a vehicle of claim 1, wherein said display portion of the information display device is movable between a display position for displaying the driving assist information for the passenger and a non-display position for enabling the upper face of the display portion to constitute the design face, and said information display device comprises a motor unit to move the display portion.

11. The attachment structure of an information display device for a vehicle of claim 2, wherein said display portion of the information display device is movable between a display position for displaying the driving assist information for the passenger and a non-display position for enabling the upper face of the display portion to constitute the design face, and said information display device comprises a motor unit to move the display portion.

12. The attachment structure of an information display device for a vehicle of claim 3, wherein said display portion of the information display device is movable between a display position for displaying the driving assist information for the passenger and a non-display position for enabling the upper face of the display portion to constitute the design face, and said information display device comprises a motor unit to move the display portion.

13. The attachment structure of an information display device for a vehicle of claim 4, wherein said display portion of the information display device is movable between a display position for displaying the driving assist information for the passenger and a non-display position for enabling the upper face of the display portion to constitute the design face, and said information display device comprises a motor unit to move the display portion.

14. The attachment structure of an information display device for a vehicle of claim 6, wherein said display portion of the information display device is movable between a display position for displaying the driving assist information for the passenger and a non-display position for enabling the upper face of the display portion to constitute the design face, and said information display device comprises a motor unit to move the display portion.

15. The attachment structure of an information display device for a vehicle of claim 7, wherein said display portion of the information display device is movable between a display position for displaying the driving assist information for the passenger and a non-display position for enabling the upper face of the display portion to constitute the design face, and said information display device comprises a motor unit to move the display portion.

16. The attachment structure of an information display device for a vehicle of claim 8, wherein said display portion of the information display device is movable between a display position for displaying the driving assist information for the passenger and a non-display position for enabling the upper face of the display portion to constitute the design face, and said information display device comprises a motor unit to move the display portion.
